(19) United States
(12) Patent Application Publication
(10) Pub. No.: US 2024/0407467 A1
(43) Pub. Date: Dec. 12, 2024

(54) AEROSOL PROVISION SYSTEM

(71) Applicant: NICOVENTURES TRADING LIMITED, London (GB)

(72) Inventor: Patrick Moloney, London (GB)

(21) Appl. No.: 18/698,827

(22) PCT Filed: Sep. 13, 2022
(86) PCT No.: PCT/GB2022/052307

§ 371 Date: Apr. 5, 2024

(30) Foreign Application Priority Data
Oct. 22, 2021 (GB) 2115185.7

(51) Int. Cl. A24F 40/60; A24F 40/42; A24F 40/46; A24F 40/50; A24F 40/65

(52) U.S. Cl. CPC A24F 40/60; A24F 40/42; A24F 40/50; A24F 40/65; A24F 40/46

(57) ABSTRACT

A customisable system 300 comprising an aerosol provision system 1 for generating an aerosol, and one or more user actuatable portions 200 which are each operable to effect a respective function. Each user actuatable portion 200 is configured to be customisable for allowing the function of that user actuatable portion 200 to be selected from a plurality of different predetermined functions. Any given user actuatable portions 200 may comprise an actuator 201 such as a button 202 on the aerosol provision system 1, or a portion of a user interface, such as an icon 256, which is configured to be displayed on a touch-sensitive display 254 from the customisable system 300.

### FIELD

The present disclosure relates to aerosol provision systems such as, but not limited to, nicotine delivery systems (e.g. electronic cigarettes and the like).

### BACKGROUND

Electronic aerosol provision systems often employ an electronic cigarette (e-cigarette) or more generally an aerosol provision device. Such an aerosol provision system typically contains aerosolisable material (also called aerosol-generating material), such as a reservoir of fluid or liquid containing a formulation, typically but not necessarily including nicotine, or a solid material such as a tobacco-based product, from which a vapour/aerosol is generated for inhalation by a user, for example through heat vaporisation. Thus, an aerosol provision system will typically comprise a vaporiser (also called an aerosol generator), e.g. a heating element, arranged to aerosolise a portion of aerosolisable material to generate a vapour.

Once a vapour has been generated, the vapour may be passed through flavouring material to add flavour to the vapour (if the aerosolisable material was not itself flavoured), after which the (flavoured) vapour may be then delivered to a user via a mouthpiece from the aerosol provision system.

A potential drawback of existing aerosol provision systems and associated aerosol provision devices is that their functionality can be fixed without any form of ability to customise the function of the aerosol provision systems between different users. This can therefore make operating these aerosol provision systems inefficient, through a given user not being able to operate the aerosol provision system in ways they might otherwise prefer. Various approaches are therefore described herein which seek to help address or mitigate some of these issues, through the introduction of a user actuatable portion whose function can be changed by the user to better suit their operating habits relating to the aerosol provision system. Approaches are also described herein for efficiently operating multiple functions relating to an aerosol provision system from a single location.

### SUMMARY

According to a first aspect of certain embodiments there is provided a customisable system comprising:
an aerosol provision system for generating an aerosol; and
one or more user actuatable portions which are each operable to effect a respective function, wherein each user actuatable portion is configured to be customisable for allowing the function of that user actuatable portion to be selected from a plurality of different predetermined functions.

According to a second aspect of certain embodiments there is provided an aerosol provision device for an aerosol provision system comprising a cartridge and the aerosol provision device, wherein the aerosol provision device comprises:
one or more user actuatable portions which are each operable to effect a respective function, wherein each user actuatable portion is configured to be customisable for allowing the function of that user actuatable portion to be selected from a plurality of different predetermined functions.

According to a third aspect of certain embodiments there is provided a method of customising the operation of a customisable system comprising an aerosol provision system for generating an aerosol, wherein the method comprises:
customising the operation of a user actuatable portion, from the customisable system, and which is configured to effect a function when the user actuatable portion is operated, by selecting the function from a plurality of different predetermined functions.

According to a fourth aspect of certain embodiments there is provided a method of operating a customisable system comprising an aerosol provision system for generating an aerosol, wherein the method comprises:
operating at least one user actuatable portion from the customisable system to effect a respective function, wherein each user actuatable portion is configured to be customisable for allowing the respective function of that user actuatable portion to be selected from a plurality of different predetermined functions.

It will be appreciated that features and aspects of the invention described above in relation to the various aspects of the invention are equally applicable to, and may be combined with, embodiments of the invention according to other aspects of the invention as appropriate, and not just in the specific combinations described herein.

### BRIEF DESCRIPTION OF THE DRAWINGS

Embodiments of the invention will now be described, by way of example only, with reference to the accompanying drawings, in which:

FIG. 1 schematically represents in perspective view an aerosol provision system comprising a cartridge and aerosol provision device (shown separated) in accordance with certain embodiments of the disclosure;

FIG. 2 schematically represents in exploded perspective view of components of the cartridge of the aerosol provision system of FIG. 1;

FIGS. 3A to 3C schematically represent various cross-section views of a housing part of the cartridge of the aerosol provision system of FIG. 1;

FIGS. 4A and 4B schematically represent a perspective view and a plan view of a dividing wall element of the cartridge of the aerosol provision system of FIG. 1;

FIGS. 5A to 5C schematically represent two perspective views and a plan view of a resilient plug of the cartridge of the aerosol provision system of FIG. 1;

FIGS. 6A and 6B schematically represent a perspective view and a plan view of a bottom cap of the cartridge of the aerosol provision system of FIG. 1;

FIG. 7 schematically represents an embodiment of customisable system, useable with an aerosol provision system such as that shown in FIGS. 1-6B, and comprising a user actuatable portion which can be operated to effect a function relating to the aerosol provision system, in accordance with certain embodiments of the disclosure;

FIG. 8A schematically represents at least one user actuatable portion located on a user interface from a display, relating to a first aerosol provision system, in accordance with certain embodiments of the disclosure;

FIG. 8B schematically represents at least one user actuatable portion located on a user interface from a display, relating to a first aerosol provision system, in accordance with certain embodiments of the disclosure;

FIG. 8C schematically represents at least one user actuatable portion located on a user interface from a display, relating to a second aerosol provision system, in accordance with certain embodiments of the disclosure; and

FIG. 9 schematically represents a portion of a user interface for customising the function of a user actuatable portion from any of FIGS. 8A-8C, in accordance with certain embodiments of the disclosure.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

The present disclosure relates to non-combustible aerosol provision systems (such as an e-cigarette). According to the present disclosure, a “non-combustible” aerosol provision system is one where a constituent aerosolisable material of the aerosol provision system (or component thereof) is not combusted or burned in order to facilitate delivery to a user. Aerosolisable material, which also may be referred to herein as aerosol generating material or aerosol precursor material, is material that is capable of generating aerosol, for example when heated, irradiated or energized in any other way. The aerosolisable material may also be flavoured, in some embodiments.

Throughout the following description the term “e-cigarette” or “electronic cigarette” may sometimes be used, but it will be appreciated this term may be used interchangeably with an aerosol provision system. An electronic cigarette may also known as a vaping device or electronic nicotine delivery system (END), although it is noted that the presence of nicotine in the aerosolisable material is not a requirement.

In some embodiments, the aerosol provision system is a hybrid device configured to generate aerosol using a combination of aerosolisable materials, one or a plurality of which may be heated. In some embodiments, the hybrid device comprises a liquid or gel aerosolisable material and a solid aerosolisable material. The solid aerosolisable material may comprise, for example, tobacco or a non-tobacco product.

Typically, the (non-combustible) aerosol provision system may comprise a cartridge/consumable part and a body/reusable/aerosol provision device part, which is configured to releasably engage with the cartridge/consumable part.

The aerosol provision system may be provided with a means for powering a vaporiser therein, and there may be provided an aerosolisable material transport element for receiving the aerosolisable material that is to be vaporised. The aerosol provision system may also be provided with a reservoir for containing aerosolisable material, and in some embodiments a further reservoir for containing flavouring material for flavouring a generated vapour from the aerosol provision system.

In some embodiments, the vaporiser may be a heater/heating element capable of interacting with the aerosolisable material so as to release one or more volatiles from the aerosolisable material to form a vapour/aerosol. In some embodiments, the vaporiser is capable of generating an aerosol from the aerosolisable material without heating. For example, the vaporiser may be capable of generating a vapour/aerosol from the aerosolisable material without applying heat thereto, for example via one or more of vibrational, mechanical, pressurisation or electrostatic means.

In some embodiments, the substance to be delivered may be an aerosolisable material which may comprise an active constituent, a carrier constituent and optionally one or more other functional constituents.

The active constituent may comprise one or more physiologically and/or olfactory active constituents which are included in the aerosolisable material in order to achieve a physiological and/or olfactory response in the user. The active constituent may for example be selected from nutraceuticals, nootropics, and psychoactives. The active constituent may be naturally occurring or synthetically obtained. The active constituent may comprise for example nicotine, caffeine, taurine, theine, a vitamin such as B6 or B12 or C, melatonin, a cannabinoid, or a constituent, derivative, or combinations thereof. The active constituent may comprise a constituent, derivative or extract of tobacco or of another botanical. In some embodiments, the active constituent is a physiologically active constituent and may be selected from nicotine, nicotine salts (e.g. nicotine ditartrate/nicotine bitartrate), nicotine-free tobacco substitutes, other alkaloids such as caffeine, or mixtures thereof.

In some embodiments, the active constituent is an olfactory active constituent and may be selected from a “flavour” and/or “flavourant” which, where local regulations permit, may be used to create a desired taste, aroma or other somatosensorial sensation in a product for adult consumers. In some instances such constituents may be referred to as flavours, flavourants, flavouring material, cooling agents, heating agents, and/or sweetening agents. They may include naturally occurring flavour materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gasone or more of extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamom, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, oil, liquid, or powder.

In some embodiments, the flavouring material (flavour) may comprise menthol, spearmint and/or peppermint. In some embodiments, the flavour comprises flavour components of cucumber, blueberry, citrus fruits and/or redberry. In some embodiments, the flavour comprises eugenol. In some embodiments, the flavour comprises flavour components extracted from tobacco. In some embodiments, the flavour may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucalyptol, WS-3.

The carrier constituent may comprise one or more constituents capable of forming an aerosol. In some embodiments, the carrier constituent may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional constituents may comprise one or more of pH regulators, colouring agents, preservatives, binders, fillers, stabilizers, and/or antioxidants.

As noted above, aerosol provision systems (e-cigarettes) may often comprise a modular assembly including both a reusable part (body- or aerosol provision device) and a replaceable consumable (cartridge) part. Devices conforming to this type of two-part modular configuration may generally be referred to as two-part devices. It is also common for electronic cigarettes to have a generally elongate shape. For the sake of providing a concrete example, certain embodiments of the disclosure described herein may comprise this kind of generally elongate two-part device employing consumable parts. However, it will be appreciated the underlying principles described herein may equally be adopted for other electronic cigarette configurations, for example modular devices comprising more than two parts, as devices conforming to other overall shapes, for example based on so-called box-mod high performance devices that typically have a more boxy shape.

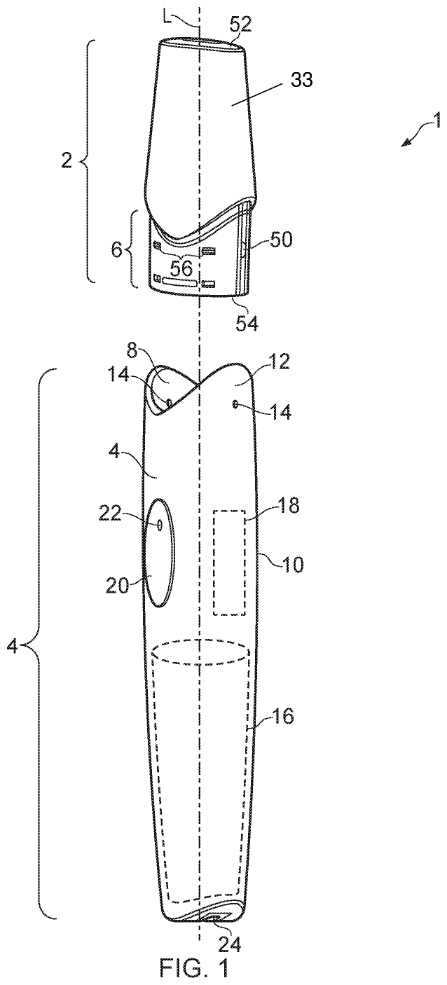

From the forgoing therefore, and with reference to FIG. 1 is a schematic perspective view of an example aerosol provision system (e-cigarette) 1 in accordance with certain embodiments of the disclosure. Terms concerning the relative location of various aspects of the electronic cigarette (e.g. terms such as upper, lower, above, below, top, bottom etc.) are used herein with reference to the orientation of the electronic cigarette as shown in FIG. 1 (unless the context indicates otherwise). However, it will be appreciated this is purely for ease of explanation and is not intended to indicate there is any required orientation for the electronic cigarette in use.

The e-cigarette 1 (aerosol provision system 1) comprises two main components, namely a cartridge 2 and an aerosol provision device 4. The aerosol provision device 4 and the cartridge 2 are shown separated in FIG. 1, but are coupled together when in use.

The cartridge 2 and aerosol provision device 4 are coupled by establishing a mechanical and electrical connection between them. The specific manner in which the mechanical and electrical connection is established is not of primary significance to the principles described herein and may be established in accordance with conventional techniques, for example based around a screw thread, bayonet, latched or friction-fit mechanical fixing with appropriately arranged electrical contacts/electrodes for establishing the electrical connection between the two parts as appropriate. For example electronic cigarette 1 represented in FIG. 1, the cartridge comprises a mouthpiece 33, a mouthpiece end 52 and an interface end 54 and is coupled to the aerosol provision device by inserting an interface end portion 6 at the interface end of the cartridge into a corresponding receptacle 8/receiving section of the aerosol provision device. The interface end portion 6 of the cartridge is a close fit to be receptacle 8 and includes protrusions 56 which engage with corresponding detents in the interior surface of a receptacle wall 12 defining the receptacle 8 to provide a releasable mechanical engagement between the cartridge and the aerosol provision device. An electrical connection is established between the aerosol provision device and the cartridge via a pair of electrical contacts on the bottom of the cartridge (not shown in FIG. 1) and corresponding sprung contact pins in the base of the receptacle 8 (not shown in FIG. 1). As noted above, the specific manner in which the electrical connection is established is not significant to the principles described herein, and indeed some implementations might not have an electrical connection between the cartridge and a aerosol provision device at all, for example because the transfer of electrical power from the reusable part to the cartridge may be wireless (e.g. based on electromagnetic induction techniques).

The electronic cigarette 1 (aerosol provision system) has a generally elongate shape extending along a longitudinal axis L. When the cartridge is coupled to the aerosol provision device, the overall length of the electronic cigarette in this example (along the longitudinal axis) is around 12.5 cm. The overall length of the aerosol provision device is around 9 cm and the overall length of the cartridge is around 5 cm (i.e. there is around 1.5 cm of overlap between the interface end portion 6 of the cartridge and the receptacle 8 of the aerosol provision device when they are coupled together). The electronic cigarette has a cross-section which is generally oval and which is largest around the middle of the electronic cigarette and tapers in a curved manner towards the ends. The cross-section around the middle of the electronic cigarette has a width of around 2.5 cm and a thickness of around 1.7 cm. The end of the cartridge has a width of around 2 cm and a thickness of around 0.6 mm, whereas the other end of the electronic cigarette has a width of around 2 cm and a thickness of around 1.2 cm. The outer housing of the electronic cigarette is in this example is formed from plastic. It will be appreciated the specific size and shape of the electronic cigarette and the material from which it is made is not of primary significance to the principles described herein and may be different in different implementations. That is to say, the principles described herein may equally be adopted for electronic cigarettes having different sizes, shapes and/or materials.

The aerosol provision device 4 may in accordance with certain embodiments of the disclosure be broadly conventional in terms of its functionality and general construction techniques. In the example of FIG. 1, the aerosol provision device 4 comprises a plastic outer housing 10 including the receptacle wall 12 that defines the receptacle 8 for receiving the end of the cartridge as noted above. The outer housing 10 of the aerosol provision device 4 in this example has a generally oval cross section conforming to the shape and size of the cartridge 2 at their interface to provide a smooth transition between the two parts. The receptacle 8 and the end portion 6 of the cartridge 2 are symmetric when rotated through 180° so the cartridge can be inserted into the aerosol provision device in two different orientations. The receptacle wall 12 includes two aerosol provision device air inlet openings 14 (i.e. holes in the wall). These openings 14 are positioned to align with an air inlet 50 for the cartridge when the cartridge is coupled to the aerosol provision device. A different one of the openings 14 aligns with the air inlet 50 of the cartridge in the different orientations. It will be appreciated some implementations may not have any degree of rotational symmetry such that the cartridge is couplable to the aerosol provision device in only one orientation while other implementations may have a higher degree of rotational symmetry such that the cartridge is couplable to the aerosol provision device in more orientations.

The aerosol provision device further comprises a battery 16 for providing operating power for the electronic cigarette, control circuitry 18 for controlling and monitoring the operation of the electronic cigarette, a user input button 20, an indicator light 22, and a charging port 24.

The battery 16 in this example is rechargeable and may be of a conventional type, for example of the kind normally used in electronic cigarettes and other applications requiring provision of relatively high currents over relatively short periods. The battery 16 may be recharged through the charging port 24, which may, for example, comprise a USB connector.

The input button 20 in this example is a conventional mechanical button, for example comprising a sprung mounted component which may be pressed by a user to establish an electrical contact in underlying circuitry. In this regard, the input button may be considered an input device for detecting user input, e.g. to trigger aerosol generation, and the specific manner in which the button is implemented is not significant. For example, other forms of mechanical button or touch-sensitive button (e.g. based on capacitive or optical sensing techniques) may be used in other implementations, or there may be no button and the device may rely on a puff detector for triggering aerosol generation.

The indicator light 22 is provided to give a user with a visual indication of various characteristics associated with the electronic cigarette, for example, an indication of an operating state (e.g. on/off/standby), and other characteristics, such as battery life or fault conditions. Different characteristics may, for example, be indicated through different colours and/or different flash sequences in accordance with generally conventional techniques.

The control circuitry 18 is suitably configured/programmed to control the operation of the electronic cigarette to provide conventional operating functions in line with the established techniques for controlling electronic cigarettes. The control circuitry (processor circuitry) 18 may be considered to logically comprise various sub-units/circuitry elements associated with different aspects of the electronic cigarette's operation. For example, depending on the functionality provided in different implementations, the control circuitry 18 may comprises power supply control circuitry for controlling the supply of power from the battery/power supply to the cartridge in response to user input, user programming circuitry for establishing configuration settings (e.g. user-defined power settings) in response to user input, as well as other functional units/circuitry associated functionality in accordance with the principles described herein and conventional operating aspects of electronic cigarettes, such as indicator light display driving circuitry and user input detection circuitry. It will be appreciated the functionality of the control circuitry 18 can be provided in various different ways, for example using one or more suitably programmed programmable computer(s) and/or one or more suitably configured application-specific integrated circuit(s)/circuitry/chip(s)/chipset(s) configured to provide the desired functionality.

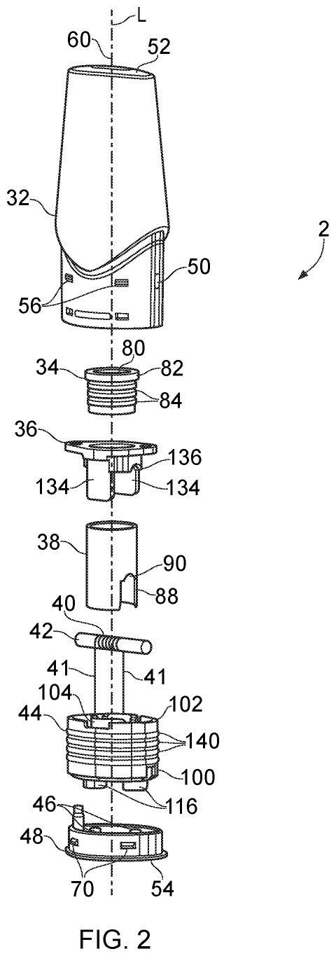

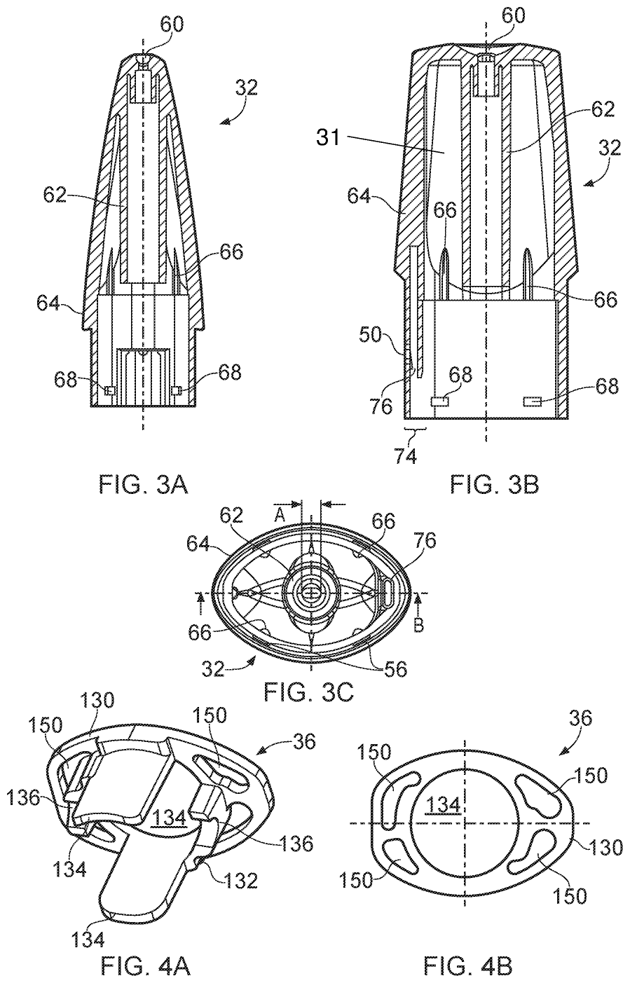

FIG. 2 is an exploded schematic perspective view of the cartridge 2 (exploded along the longitudinal axis L). The cartridge 2 comprises a housing part 32, an air channel seal 34, a dividing wall element 36, an outlet tube 38, a vaporiser/heating element 40, an aerosolisable material transport element 42, a plug 44, and an end cap 48 with contact electrodes 46. FIGS. 3 to 6 schematically represents some of these components in more detail.

FIG. 3A is a schematic cut-away view of the housing part 32 through the longitudinal axis L where the housing part 32 is thinnest. FIG. 3B is a schematic cut-away view of the housing part 32 through the longitudinal axis L where the housing part 32 is widest. FIG. 3C is a schematic view of the housing part along the longitudinal axis L from the interface end 54 (i.e. viewed from below in the orientation of FIGS. 3A and 3B).

FIG. 4A is a schematic perspective view of the dividing wall element 36 as seen from below. FIG. 4B is a schematic cross-section through an upper part of the dividing wall element 36 as viewed from below.

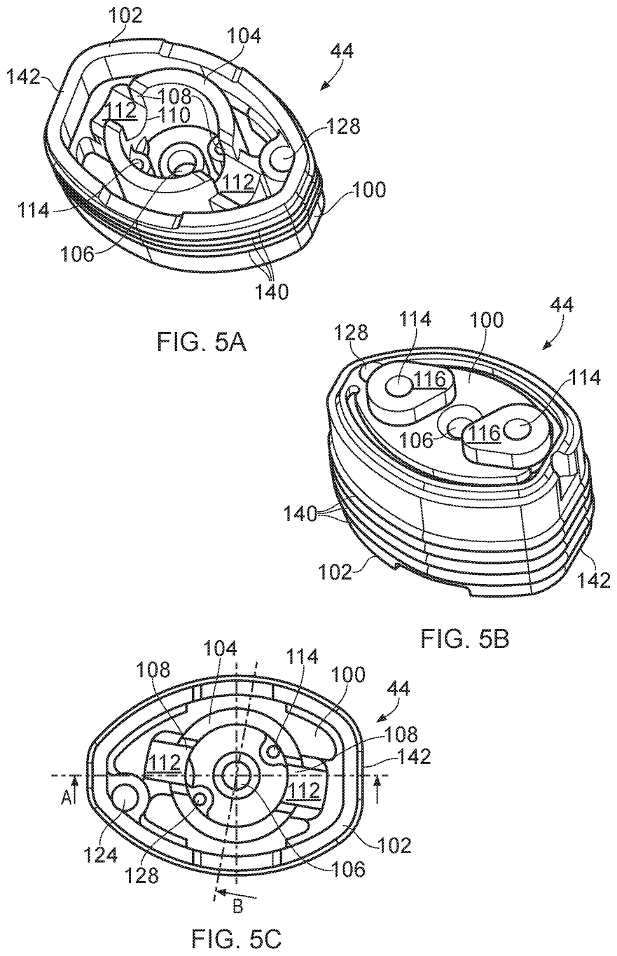

FIG. 5A is a schematic perspective view of the plug 44 from above and FIG. 5B is a schematic perspective view of the plug 44 from below. FIG. 5C is a schematic view of the plug 44 along the longitudinal axis L seen from the mouthpiece end 52 of the cartridge (i.e. viewed from above for the orientation in FIGS. 1 and 2).

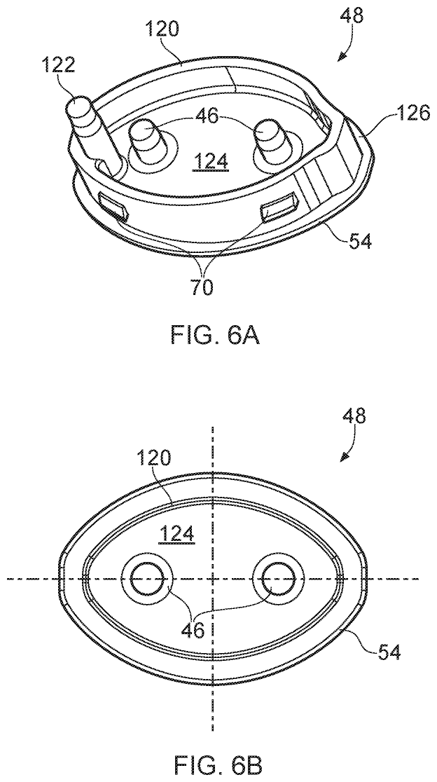

FIG. 6A is a schematic perspective view of the end cap 48 from above. FIG. 6B is a schematic view of the end cap 48 along the longitudinal axis L seen from the mouthpiece end 52 of the cartridge (i.e. from above).

The housing part 32 in this example comprises a housing outer wall 64 and a housing inner tube 62 which in this example are formed from a single moulding of polypropylene. The housing outer wall 64 defines the external appearance of the cartridge 2 and the housing inner tube 62 defines a part the air channel through the cartridge. The housing part is open at the interface end 54 of the cartridge and closed at the mouthpiece end 52 of the cartridge except for a mouthpiece opening/aerosol outlet 60, from the mouthpiece 33, which is in fluid communication with the housing inner tube 62. The housing part 32 includes an opening in a sidewall which provides the air inlet 50 for the cartridge. The air inlet 50 in this example has an area of around 2 mm². The outer surface of the outer wall 64 of the housing part 32 includes the protrusions 56 discussed above which engage with corresponding detents in the interior surface of the receptacle wall 12 defining the receptacle 8 to provide a releasable mechanical engagement between the cartridge and the aerosol provision device. The inner surface of the outer wall 64 of the housing part includes further protrusions 66 which act to provide an abutment stop for locating the dividing wall element 36 along the longitudinal axis L when the cartridge is assembled. The outer wall 64 of the housing part 32 further comprises holes which provide latch recesses 68 arranged to receive corresponding latch projections 70 in the end cap to fix the end cap to be housing part when the cartridge is assembled.

The outer wall 64 of the housing part 32 includes a double-walled section 74 that defines a gap 76 in fluid communication with the air inlet 50. The gap 76 provides a portion of the air channel through the cartridge. In this example the doubled-walled section 74 of the housing part 32 is arranged so the gap defines an air channel running within the housing outer wall 64 parallel to the longitudinal axis with a cross-section in a plane perpendicular to the longitudinal axis of around 3 mm². The gap/portion of air channel 76 defined by the double-walled section of the housing part extends down to the open end of the housing part 32.

The air channel seal 34 is a silicone moulding generally in the form of a tube having a through hole 80. The outer wall of the air channel seal 34 includes circumferential ridges 84 and an upper collar 82. The inner wall of the air channel seal 34 also includes circumferential ridges, but these are not visible in FIG. 2. When the cartridge is assembled the air channel seal 34 is mounted to the housing inner tube 62 with an end of the housing inner tube 62 extending partly into the through hole 80 of the air channel seal 34. The through hole 80 in the air channel seal has a diameter of around 5.8 mm in its relaxed state whereas the end of the housing inner tube 62 has a diameter of around 6.2 mm so that a seal is formed when the air channel seal 34 is stretched to accommodate the housing inner tube 62. This seal is facilitated by the ridges on the inner surface of the air channel seal 34.

The outlet tube 38 comprises a tubular section, for instance made of ANSI 304 stainless steel or polypropylene, with an internal diameter of around 8.6 mm and a wall thickness of around 0.2 mm. The bottom end of the outlet tube 38 includes a pair of diametrically opposing slots 88 with an end of each slot having a semi-circular recess 90. When the cartridge is assembled the outlet tube 38 mounts to the outer surface of the air channel seal 34. The outer diameter of the air channel seal is around 9.0 mm in its relaxed state so that a seal is formed when the air channel seal 34 is compressed to fit inside the outlet tube 38.

This seal is facilitated by the ridges 84 on the outer surface of the air channel seal 34. The collar 80 on the air channel seal 34 provides a stop for the outlet tube 38.

The aerosolisable material transport element 42 comprises a capillary wick and the vaporiser (aerosol generator) 40 comprises a resistance wire heater wound around the capillary wick. In addition to the portion of the resistance wire wound around the capillary wick, the vaporiser comprises electrical leads 41 which pass through holes in the plug 44 to contact electrodes 46 mounted to the end cap 54 to allow power to be supplied to the vaporiser via the electrical interface the established when the cartridge is connected to an aerosol provision device. The vaporiser leads 41 may comprise the same material as the resistance wire wound around the capillary wick, or may comprise a different material (e.g. lower-resistance material) connected to the resistance wire wound around the capillary wick. In this example the heater coil 40 comprises a nickel iron alloy wire and the wick 42 comprises a glass fibre bundle. The vaporiser and aerosolisable material transport element may be provided in accordance with any conventional techniques and is may comprise different forms and/or different materials. For example, in some implementations the wick may comprise fibrous or solid a ceramic material and the heater may comprise a different alloy. In other examples the heater and wick may be combined, for example in the form of a porous and a resistive material. More generally, it will be appreciated the specific nature aerosolisable material transport element and vaporiser is not of primary significance to the principles described herein.

When the cartridge is assembled, the wick 42 is received in the semi-circular recesses 90 of the outlet tube 38 so that a central portion of the wick about which the heating coil is would is inside the outlet tube while end portions of the wick are outside the outlet tube 38.

The plug 44 in this example comprises a single moulding of silicone, may be resilient. The plug comprises a base part 100 with an outer wall 102 extending upwardly therefrom (i.e. towards the mouthpiece end of the cartridge). The plug further comprises an inner wall 104 extending upwardly from the base part 100 and surrounding a through hole 106 through the base part 100.

The outer wall 102 of the plug 44 conforms to an inner surface of the housing part 32 so that when the cartridge is assembled the plug in 44 forms a seal with the housing part 32. The inner wall 104 of the plug 44 conforms to an inner surface of the outlet tube 38 so that when the cartridge is assembled the plug 44 also forms a seal with the outlet tube 38. The inner wall 104 includes a pair of diametrically opposing slots 108 with the end of each slot having a semi-circular recess 110. Extended outwardly (i.e. in a direction away from the longitudinal axis of the cartridge) from the bottom of each slot in the inner wall 104 is a cradle section 112 shaped to receive a section of the aerosolisable material transport element 42 when the cartridge is assembled. The slots 108 and semi-circular recesses 110 provided by the inner wall of the plug 44 and the slots 88 and semi-circular recesses 90 of the outlet tube 38 are aligned so that the slots 88 in the outlet tube 38 accommodate respective ones of the cradles 112 with the respective semi-circular recesses in the outlet tube and plug cooperating to define holes through which the aerosolisable material transport element passes. The size of the holes provided by the semi-circular recesses through which the aerosolisable material transport element passes correspond closely to the size and shape of the aerosolisable material transport element, but are slightly smaller so a degree of compression is provided by the resilience of the plug 44. This allows aerosolisable material to be transported along the aerosolisable material transport element by capillary action while restricting the extent to which aerosolisable material which is not transported by capillary action can pass through the openings. As noted above, the plug 44 includes further openings 114 in the base part 100 through which the contact leads 41 for the vaporiser pass when the cartridge is assembled. The bottom of the base part of the plug includes spacers 116 which maintain an offset between the remaining surface of the bottom of the base part and the end cap 48. These spacers 116 include the openings 114 through which the electrical contact leads 41 for the vaporiser pass.

The end cap 48 comprises a polypropylene moulding with a pair of gold-plated copper electrode posts 46 mounted therein.

The ends of the electrode posts 44 on the bottom side of the end cap are close to flush with the interface end 54 of the cartridge provided by the end cap 48. These are the parts of the electrodes to which correspondingly aligned sprung contacts in the aerosol provision device 4 connect when the cartridge 2 is assembled and connected to the aerosol provision device 4. The ends of the electrode posts on the inside of the cartridge extend away from the end cap 48 and into the holes 114 in the plug 44 through which the contact leads 41 pass. The electrode posts are slightly oversized relative to the holes 114 and include a chamfer at their upper ends to facilitate insertion into the holes 114 in the plug where they are maintained in pressed contact with the contact leads for the vaporiser by virtue of the plug.

The end cap has a base section 124 and an upstanding wall 120 which conforms to the inner surface of the housing part 32. The upstanding wall 120 of the end cap 48 is inserted into the housing part 32 so the latch projections 70 engage with the latch recesses 68 in the housing part 32 to snap-fit the end cap 48 to the housing part when the cartridge is assembled. The top of the upstanding wall 120 of the end cap 48 abuts a peripheral part of the plug 44 and the lower face of the spacers 116 on the plug also abut the base section 124 of the plug so that when the end cap 48 is attached to the housing part it presses against the resilient part 44 to maintain it in slight compression.

The base portion 124 of the end cap 48 includes a peripheral lip 126 beyond the base of the upstanding wall 112 with a thickness which corresponds with the thickness of the outer wall of the housing part at the interface end of the cartridge. The end cap also includes an upstanding locating pin 122 which aligns with a corresponding locating hole 128 in the plug to help establish their relative location during assembly.

The dividing wall element 36 comprises a single moulding of polypropylene and includes a dividing wall 130 and a collar 132 formed by projections from the dividing wall 130 in the direction towards the interface end of the cartridge. The dividing wall element 36 has a central opening 134 through which the outlet tube 38 passes (i.e. the dividing wall is arranged around the outlet tube 38). In some embodiments, the dividing wall element 36 may be integrally formed with the outlet tube 38. When the cartridge is assembled, the upper surface of the outer wall 102 of the plug 44 engages with the lower surface of the dividing wall 130, and the upper surface of the dividing wall 130 in turn engages with the projections 66 on the inner surface of the outer wall 64 of the housing part 32. Thus, the dividing wall 130 prevents the plug from being pushed too far into the housing part 32—i.e. the dividing wall 130 is fixedly located along the longitudinal axis of the cartridge by the protrusions 66 in the housing part and so provides the plug with a fixed surface to push against. The collar 132 formed by projections from the dividing wall includes a first pair of opposing projections/tongues 134 which engage with corresponding recesses on an inner surface of the outer wall 102 of the plug 44. The protrusions from the dividing wall 130 further provide a pair of cradle sections 136 configured to engage with corresponding ones of the cradle sections 112 in the part 44 when the cartridge is assembled to further define the opening through which the aerosolisable material transport element passes.

When the cartridge 2 is assembled an air channel extending from the air inlet 50 to the aerosol outlet 60 through the cartridge is formed. Starting from the air inlet 50 in the side wall of the housing part 32, a first section of the air channel is provided by the gap 76 formed by the double-walled section 74 in the outer wall 64 of the housing part 32 and extends from the air inlet 50 towards the interface end 54 of the cartridge and past the plug 44. A second portion of the air channel is provided by the gap between the base of the plug 44 and the end cap 48. A third portion of the air channel is provided by the hole 106 through the plug 44. A fourth portion of the air channel is provided by the region within the inner wall 104 of the plug and the outlet tube around the vaporiser 40. This fourth portion of the air channel may also be referred to as an aerosol/aerosol generation region, it being the primary region in which aerosol is generated during use. The air channel from the air inlet 50 to the aerosol generation region may be referred to as an air inlet section of the air channel. A fifth portion of the air channel is provided by the remainder of the outlet tube 38. A sixth portion of the air channel is provided by the outer housing inner tube 62 which connects the air channel to the aerosol outlet 60, which is located at an end of the mouthpiece 33. The air channel from the aerosol generation region to be the aerosol outlet may be referred to as an aerosol outlet section of the air channel.

Also, when the cartridge is assembled a reservoir 31 for aerosolisable material is formed by the space outside the air channel and inside the housing part 32. This may be filled during manufacture, for example through a filling hole which is then sealed, or by other means. The specific nature of the aerosolisable material, for example in terms of its composition, is not of primary significance to the principles described herein, and in general any conventional aerosolisable material of the type normally used in electronic cigarettes may be used. The present disclosure may refer to a liquid as the aerosolisable material, which as mentioned above may be a conventional e-liquid. However, the principles of the present disclosure apply to any aerosolisable material which has the ability to flow, and may include a liquid, a gel, or a solid, where for a solid a plurality of solid particles may be considered to have the ability to flow when considered as a bulk.

The reservoir is closed at the interface end of the cartridge by the plug 44. The reservoir includes a first region above the dividing wall 130 and a second region below the dividing wall 130 within the space formed between the air channel and the outer wall of the plug. The aerosolisable material transport element (capillary wick) 42 passes through openings in the wall of the air channel provided by the semi-circular recesses 108, 90 in the plug 44 and the outlet tube 38 and the cradle sections 112, 136 in the plug 44 and the dividing wall element 36 that engage with one another as discussed above. Thus, the ends of the aerosolisable material transport element extend into the second region of the reservoir from which they draw aerosolisable material through the openings in the air channel to the vaporiser 40 for subsequent vaporisation.

In normal use, the cartridge 2 is coupled to the aerosol provision device 4 and the aerosol provision device activated to supply power to the cartridge via the contact electrodes 46 in the end cap 48. Power then passes through the connection leads 41 to the vaporiser 40. The vaporiser is thus electrically heated and so vaporises a portion of the aerosolisable material from the aerosolisable material transport element in the vicinity of the vaporiser. This generates aerosol in the aerosol generation region of the air path. Aerosolisable material that is vaporised from the aerosolisable material transport element is replaced by more aerosolisable material drawn from the reservoir by capillary action. While the vaporiser is activated, a user inhales on the mouthpiece end 52 of the cartridge. This causes air to be drawn through whichever aerosol provision device air inlet 14 aligns with the air inlet 50 of the cartridge (which will depend on the orientation in which the cartridge was inserted into the aerosol provision device receptacle 8). Air then enters the cartridge through the air inlet 50, passes along the gap 76 in the double-walled section 74 of the housing part 32, passes between the plug 44 and the end cap 48 before entering the aerosol generation region surrounding the vaporiser 40 through the hole 106 in the base part 100 of the plug 44. The incoming air mixes with aerosol generated from the vaporiser to form a condensation aerosol, which is then drawn along the outlet tube 38 and the housing part inner 62 before exiting through the mouthpiece outlet/aerosol outlet 60 for user inhalation.

From the above FIGS. 1-6B, it can be seen a possible embodiment construction of aerosol provision system 1 which is configured for generating an aerosol, which is suitable for use in the context of the present disclosure (alongside potentially other forms of aerosol provision system).

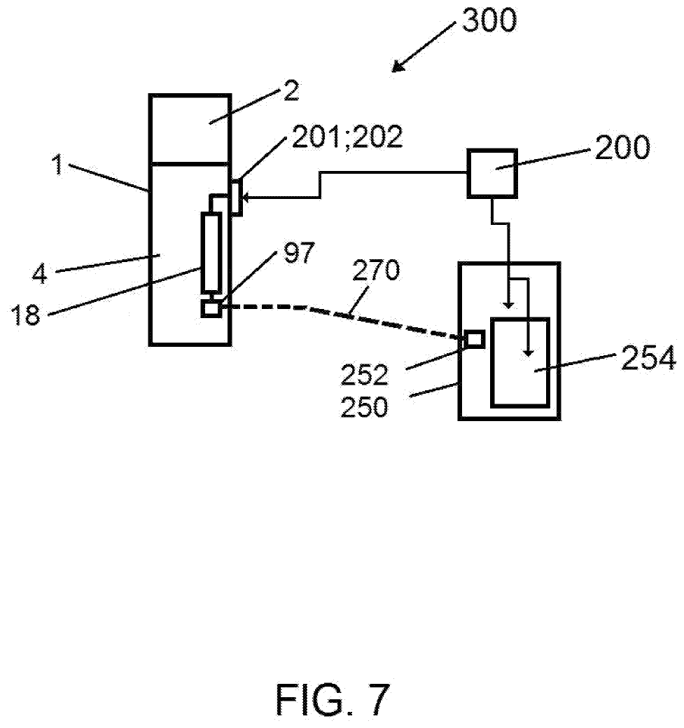

Turning now to FIGS. 7-9, the present disclosure also provides for a customisable system 300 comprising one or more user actuatable portions 200 which are each operable to effect a respective function, wherein each user actuatable portion 200 is configured, in accordance with some embodiments, to be customisable for allowing the function of that user actuatable portion to be selected from a plurality of different predetermined functions, and/or for allowing the function to be changed from a first predetermined function to a second predetermined function.

In some embodiments therefore, each user actuatable portion 200 may thus serve to function as a customisable portion of the customisable system 300, to thus allow the user to tailor its functionality to a function which that particular user often uses.

Mindful of the above therefore, it may be appreciated that the respective function of each user actuatable portion 200 may be a function of, and/or a function relating to, the aerosol provision system 1 or the customisable system 300.

As to the location of each user actuatable portion 200, in accordance with some embodiments, such as that shown in one of the embodiments of FIG. 7, any given user actuatable portion 200 may be located on the aerosol provision system 1 itself, i.e. put differently such that the aerosol provision system 1 comprises the user actuatable portion 200.

In accordance with some embodiments however, as also shown in one of the embodiments from FIG. 7, any given user actuatable portion 200 may be located on an electrical device 250 which is operable to wirelessly communicate with the aerosol provision system 1, e.g. via a wireless connection protocol 270. In this way, the user may be operable to effect the function, such as a function of the aerosol provision system 1, even when the user is not necessarily touching or holding the aerosol provision system 1.

As to what such an electrical device 250 might be, it is envisaged that this may comprise any form of electrical device which might operably communicate with the aerosol provision system 1, such as (and certainly not limited to) any of a portable device, such as a tablet computer, smartphone, portable computer, or even a desktop computer, server or other multipurpose computing device. As required, it will be appreciated that the electrical device 250 may be operable to communicate with the aerosol provision system 1, such as wirelessly via the wireless connection protocol 270. In this case therefore, appreciably the electrical device 250 may then also comprise a wireless transmitter/receiver/transceiver 252, as appropriate, to facilitate any such wireless communication with the aerosol provision system 1 (which equally may then also comprise a wireless transmitter/receiver/transceiver 97 in communication with the control circuitry 18). As to what this wireless connection protocol may be, it may be appreciated that this could comprise in some more limited embodiments a wireless local area network “WLAN” connection protocol; or a wireless telecommunications connection protocol; and/or more simply a Bluetooth protocol (which might include both Bluetooth™ or Bluetooth Low Energy (BTLE), also known as Bluetooth Smart).

Irrespective of the location of any given user actuatable portion 200, however, each user actuatable portion 200 may take a variety of different forms. In this respect for instance, and in accordance with some embodiments, a given user actuatable portion 200 may comprise an actuator 201, such a mechanical actuator or electrically operated actuator, which can be actuated to operate the function. Such an actuator 201, in accordance with some particular embodiments, could comprise a button 202 or a switch (e.g. a capacitive switch), for instance. Any such actuator 201 might then, in accordance with some very particular embodiments, be an actuator which is located on a surface of the aerosol provision system 1, such as an external surface thereof. In some particular embodiments, the actuator 201 could be located on an aerosol provision device 4 from the aerosol provision system 1 (where the aerosol provision system 1 comprises such a cartridge 2/aerosol provision device 4 type arrangement, as shown in the embodiment of FIG. 7).

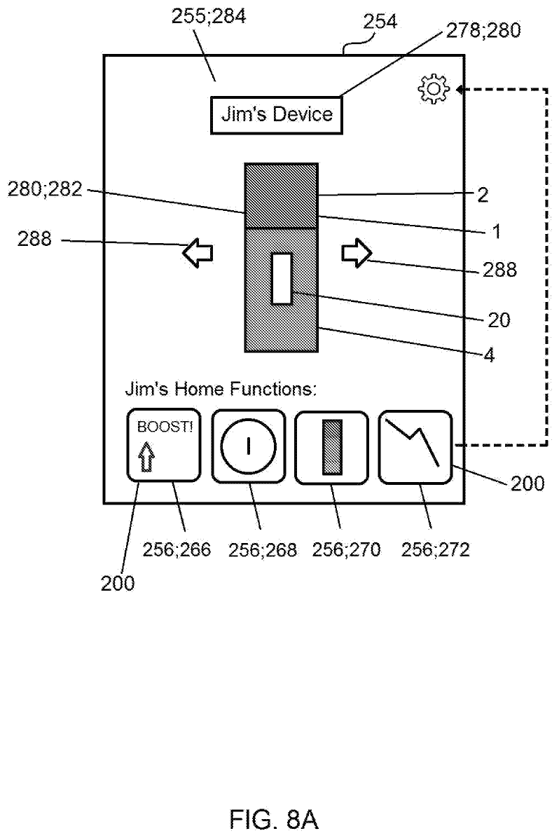

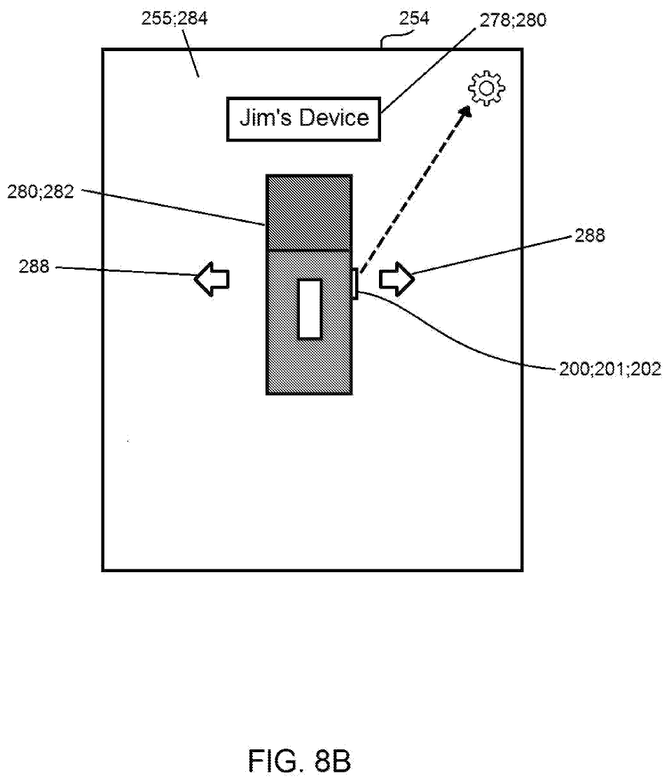

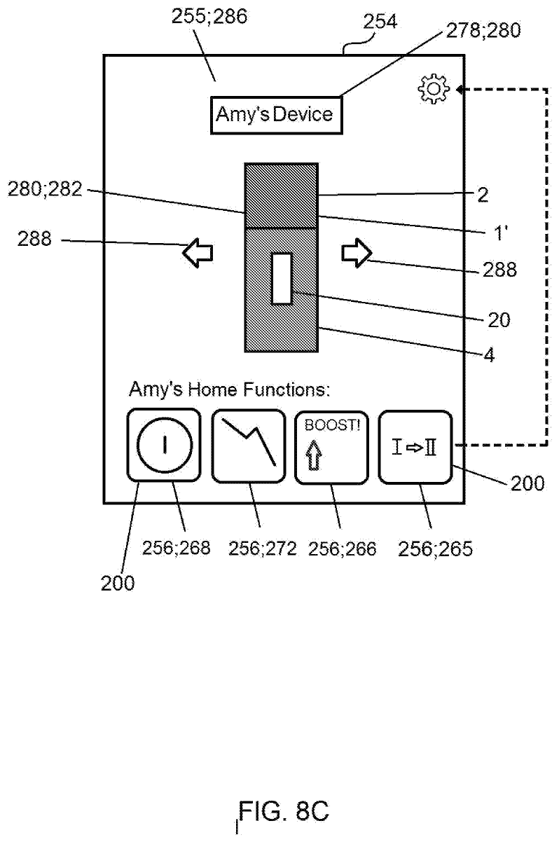

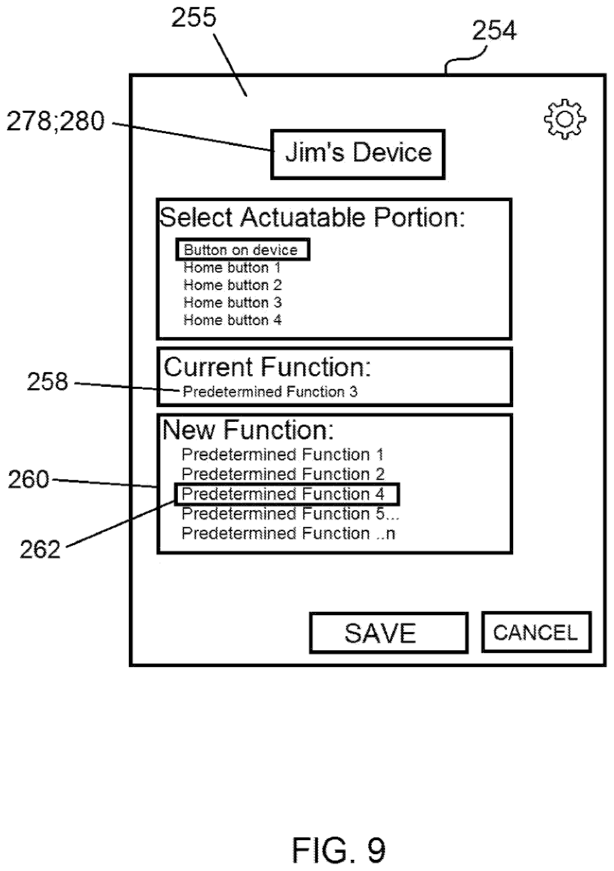

Equally, and in accordance with some additional/alternative embodiments, such as those shown in FIGS. 8A-9, the customisable system 300 may comprise a touch-sensitive display 254, such that any given user actuatable portion 200 may comprise at least one portion of a user interface 255 which is configured to be displayed on the touch-sensitive display 254, which in accordance with some particular embodiments could be located on the aerosol provision system 1 (such as on any aerosol provision device 4 therefrom) or located on the electrical device 250. An example of such a user interface 255 is illustrated in the embodiment of FIGS. 8A-9. In this way for instance, and in accordance with some particular embodiments thereof, each portion of the user interface 255 may comprise an icon 256 (such as one icon 256 for a given user actuatable portion 200).

Mindful of the above disclosure therefore, any provided user actuatable portion 200 may be configured to be customisable in accordance with some embodiments, for allowing its function to be changed from a first predetermined function 258 to a second predetermined function 262. This is best explained with reference to the disclosure from FIG. 9. In this respect therefore, and in accordance with some embodiments, the customisable system 300 may be configured to allow the user to select the function for any given user actuatable portion 200 from a list of predetermined different functions 260.

As to what any of these different functions might be, it will be appreciated that these may comprises a variety of different functions for either effecting an operation of, or an operation relating to, the aerosol provision system 1 and/or the customisable system 300. Equally, in accordance with some embodiments, each such function may comprise a function for outputting a feedback signal.

Appreciably therefore, and in accordance with some embodiments for instance, the function of any given user actuatable portion 200 may potentially comprise any of the following functions-which are not to be considered exhaustive:
i) an operation of the aerosol provision system 1. In accordance with some particular embodiments, this could be an operation of a vaporiser 40 from the aerosol provision system 1, or some other operation of the aerosol provision system 1.
ii) an operation 265 to switch a mode of operation of the aerosol provision system 1, from or between a first mode of operation, to a second mode of operation which is different from the first mode operation. Such an operation could be useful in accordance with some embodiments to allow the user to more quickly switch between these two modes of operation.
iii) an operation 266 to change (such as increase or decrease) the power supplied to the vaporiser 40 to the aerosol provision system. In this way, the user actuatable portion 200 may conveniently be able to quickly change the power supplied to the vaporiser 40 (e.g. between one or more predetermined levels, in accordance with some particular embodiments thereof). Where the power supplied to the vaporiser 40 is changed in these embodiments, in accordance with some embodiments, the change may be for a predetermined amount of time, or for predetermined number of operations of the vaporiser (i.e. such that the change is temporary), or could be permanent (e.g. until such time as the user instruct the power supplied to the vaporiser 40 to the aerosol provision system to be changed again).
iv) an operation to change (such as increase or decrease) the amount or rate of aerosolisable material which is vaporised by the aerosol provision system 1. In this way, the user actuatable portion 200 may again be operable to allow the user to quickly change the extent of aerosolisable material which is delivered by the aerosol provision system 1 (e.g. between one or more predetermined levels, in accordance with some particular embodiments thereof). Again, any such change in accordance with such embodiments may be either temporary or permanent.
v) an operation 268 to turn on and/or turn off the aerosol provision system 1.
vi) an operation which is configured to generate a signal containing usage information for the aerosol provision system 1. Appreciably, where such usage information is generated, this could then be configured to be output by the customisable system 300 to a remote location, such as to the electrical device 250 (e.g. to a memory thereof) or to another predetermined location (such as a server; or a manufacturer/supplier of the aerosol provision system 1 and/or to another electrical device (such as any other form of electrical device described herein).
vii) an operation 269 which is configured to modify the appearance of the aerosol provision system. For instance, in accordance with some embodiments, the aerosol provision system 1 may comprise a portion whose appearance is configured to be customised. In this way, in response the operation which is configured to modify the appearance of the aerosol provision system 1, the aerosol provision system 1 may be configured to modify the appearance of the portion whose appearance is configured to be customised.
viii) an operation which is to configured output an audio signal from the aerosol provision system 1. This could be helpful, in accordance with some embodiments, in cases where the aerosol provision system 1 is deemed as lost by the user, such that audio signal could be helpful to the user to determine where the aerosol provision system 1 might be found.
ix) an operation to disable the aerosol provision system 1. In accordance with some particular embodiments this may be an operation to either disable the aerosol provision system 1 for a predetermined period of time (e.g. to cater for instances when the user wishes to control their usage of the device, and/or to prevent the device being used in the case the device falls into the hands of a minor/child), and/or an operation to permanently disable the aerosol provision system 1 (e.g. to cater for instances when the aerosol provision system 1 is deemed lost by the user, and/or in instances where the user wishes to permanently disable the aerosol provision system 1—such as when they are disposing of the aerosol provision system 1). Such an operation to disable the aerosol provision system 1 may also comprise, in some embodiments, an operation to lock, and/or unlock, the aerosol provision system. In this way, the operation may thus allow the user some control to disable, and/or prevent, the aerosol provision system from generating an aerosol, for instance during times when the aerosol provision system might need to be disabled, such as whilst on an aeroplane, or in a building (such as a hospital or theatre) where it may be prohibited from generating an aerosol using the aerosol provision system.
x) a function 272 for outputting a feedback signal. In accordance with some particular embodiments, the feedback signal may comprise any form of feedback data pertaining to an operation of the aerosol provision system 1. For instance, and in accordance with some embodiments, the feedback signal may comprise feedback data comprising an indication that the delivered aerosolisable material from the aerosol provision system is too hot, or is too cold. Equally, in accordance with some additional or alternative embodiments, the feedback signal may comprise feedback data comprising an indication that the aerosolisable material was delivered for a duration which was either too short or too long.

In so far as there may be provided a function for outputting a feedback signal, in accordance with some embodiments thereof, the customisable system 300 may be configured to output the feedback signal to the aerosol provision system 1. In this way, the aerosol provision system (such as any control circuitry 18 therefrom, in accordance with some embodiments) may be then configured to vary an operating parameter of the aerosol provision system 1 (such as the duration of the operation of the vaporiser 40, and/or the amount of power supplied to the vaporiser, and/or the temperature of the vaporiser 40) using the feedback data contained in the feedback signal. Where necessary, the aerosol provision system 1 may be configured to store the feedback data in a memory of the aerosol provision system 1 (and which may be in communication with the control circuitry 18).

Equally, in so far as there may be provided a function for outputting a feedback signal, in accordance with some embodiments thereof, the customisable system 300 may be configured to output the feedback signal to an electrical device, such as the electrical device 250. In this way, the customisable system 300 may be then configured, in accordance with some embodiments, to store the feedback data in a memory of the electrical device (e.g. for data logging purposes).

For completeness as well, in so far as any user actuatable portion(s) 200 may be configured to be displayed on the display 254 of an electrical device 250, such as potentially a touch-sensitive display in accordance with some particular embodiments, to more conveniently allow the user to discern what aerosol provision system 1 each user actuatable portion 200 is configured to function with, the electrical device 250 in accordance with some embodiments may be configured, for each aerosol provision system 1, to output an indication 278 of the respective aerosol provision system 1 on the display 254. Such an indication appreciably cold take a number of different forms, such as in accordance with some particular embodiments may comprise a portion of text 280 (e.g. ‘Jim's device’ in accordance with the embodiments illustrated in FIGS. 8A and 8B, or ‘Amy's device’ in accordance with the disclosure from FIG. 8C) indicating an identity of the aerosol provision system 1 on the display 254. Equally, in accordance with some additional or alternative embodiments, the indication 278 may comprise a graphical representation 282 of the aerosol provision system. Such a graphical representation 282, appreciably in some embodiments, could include any of the shape of the aerosol provision system; the model of the aerosol provision system (such as the model being an ‘ePen3’; and ‘ePod2+’ or a ‘Glo’ aerosol provision system); and/or a colour(s) of the aerosol provision system.

It is to be understood as well, in accordance with some embodiments, that the electrical device 250 may be configured is allow a user of the electrical device 250 to toggle the user interface 255 between a first portion 284 (e.g. as shown in the embodiment of FIG. 8A) of the user interface 255 which is configured to allow each actuatable portion 250; 256 to be operable to effect a respective function of the (first) aerosol provision system 1 (e.g. Jim's device); and a second portion 286 (e.g. as shown in the embodiment of FIG. 8C) of the user interface 255 which is configured to allow each actuatable portion 250; 256 to be operable to effect a respective function of a second aerosol provision system 1′, which may be different from the first aerosol provision system 1 (e.g. Amy's device). Such toggling could be achieved by way of the user interface comprising at least one toggle portion 288 (such as a list of the aerosol provision systems 1; 1′, or a graphical indicator which allows the user to cycle between the aerosol provision systems) for allowing the user to toggle the user interface 255 between the first portion 284 and the second portion 286.

Purely for completeness, and with respect to the location of the predetermined functions, it will be appreciated that these may be stored and/or retrieved from any required location, depending on the application of the user actuatable portion 200. For instance, in accordance with some embodiments, the predetermined functions may be located in a memory from the electrical device 250, or could be located in a memory of the aerosol provision system 1 in accordance with some embodiments where the user actuatable portion 200 is located on the aerosol provision system 1.

As to the location of any of the plurality of actuatable portions 256 as well, in embodiments where these are displayed on the graphical user interface 255 (such as in the embodiments illustrated in FIGS. 8A-8C) from the electrical device 250, it will be appreciated that in some of these embodiments, the plurality of actuatable portions 256 may be configured to be located on a same half/side of the graphical user interface 255, such as on the same half/side of the first portion 284 of the graphical user interface 255 (in the case of Jim's device as shown in the embodiment of FIG. 8A, where the plurality of actuatable portions 256 are all located in the lower half/side of the first portion 284), and/or on the same half/side of the second portion 286 of the graphical user interface 255 (in the case of Amy's device as shown in the embodiment of FIG. 8C, where the plurality of actuatable portions 256 are all located in the lower half/side of the first portion 286). By thus having all the actuatable portions 256 on a same half/side of the graphical user interface 255, this has been found to make it easier for the user to understand where each of the actuatable portions 256 is located, thus making them more easy to identify and operate for the user in the medium to long term.

Equally as well, and staying with location of any of the plurality of actuatable portions 256, in embodiments where these are displayed on the graphical user interface 255 (such as in the embodiments illustrated in FIGS. 8A-8C) from the electrical device 250, it will be appreciated that in some of these embodiments, the graphical user interface may be configured to display any additionally present graphical representation of the aerosol provision system next to each such user actuatable portion, as shown for instance in the embodiments illustrated in FIGS. 8A-8C. Thus by having the graphical representation of the aerosol provision system next to each such user actuatable portion, the user may be more easily able to visually confirm, prior to operating the given user actuatable portion, that they will be operating the given user actuatable portion which relates to the aerosol provision system whose graphical representation is shown next to it. In this way, the user may then be able to more easily avert any unintended operation of one aerosol provision system (e.g. relating to Jim's device as shown in FIG. 8A) as opposed to another aerosol provision system (e.g. relating to Amy's device as shown in FIG. 8C).

Appreciating the foregoing therefore, it may be appreciated that the customisable system 300 may be provided with at least one user actuatable portion 200 which is operable to effect a function, and wherein each such user actuatable portion 200 may be configured to be customisable for allowing the function to be changed as required by the user.

For completeness therefore, it is to be appreciated that the customisable system 300 may comprise one or a plurality of such user actuatable portions 200. In this way, and where a plurality of the user actuatable portions is provided, each user actuatable portion may be configured to be individually customisable for allowing the function pertaining to that user actuatable portion to be changed as required by the user.

Thus in accordance with the above embodiments where more than one user actuatable portion 200 is provided, it will be appreciated that more than one actuator 201 on the aerosol provision system 1 may be provided, and/or or more than one icon 256 may be provided on any provided display 254 as part of the user interface 255. Equally, there may even be provided a combination of such an actuator(s) 201 and an icon 256 on the display 254 as part of the customisable system 300.

Appreciating the foregoing therefore, there has accordingly been described a customisable system comprising:
an aerosol provision system for generating an aerosol; and
one or more user actuatable portions which are each operable to effect a respective function, wherein each user actuatable portion is configured to be customisable for allowing the function of that user actuatable portion to be selected from a plurality of different predetermined functions.

There has also been described an aerosol provision device for an aerosol provision system comprising a cartridge and the aerosol provision device, wherein the aerosol provision device comprises:
one or more user actuatable portions which are each operable to effect a respective function, wherein each user actuatable portion is configured to be customisable for allowing the function of that user actuatable portion to be selected from a plurality of different predetermined functions.

There has also been described a method of customising the operation of a customisable system comprising an aerosol provision system for generating an aerosol, wherein the method comprises:
customising the operation of a user actuatable portion, from the customisable system, and which is configured to effect a function when the user actuatable portion is operated, by selecting the function from a plurality of different predetermined functions.

There has also been described a method of operating a customisable system comprising an aerosol provision system for generating an aerosol, wherein the method comprises:
operating at least one user actuatable portion from the customisable system to effect a respective function, wherein each user actuatable portion is configured to be customisable for allowing the respective function of that user actuatable portion to be selected from a plurality of different predetermined functions.

There has also been described an electrical device for use with an aerosol provision system for generating an aerosol, wherein the electrical device comprises:
a display; and
at least one actuatable portion, wherein each user actuatable portion is operable to effect a respective function, wherein each user actuatable portion is configured to be displayed on the display, and is configured to be customisable for allowing the function of the aerosol provision system for that user actuatable portion to be selected from a plurality of different predetermined functions.

There has also been described a method of using an electrical device configured for use with an aerosol provision device system for generating an aerosol, wherein the method comprises:
customising the operation of at least one user actuatable portion, which is displayed on a display of the electrical device, and which is configured to effect a function when the user actuatable portion is operated, by selecting the function from a plurality of different predetermined functions.

There has also been described a customisable system 300 comprising an aerosol provision system 1 for generating an aerosol, and one or more user actuatable portions 200 which are each operable to effect a respective function. Each user actuatable portion 200 is configured to be customisable for allowing the function of that user actuatable portion 200 to be selected from a plurality of different predetermined functions. Any given user actuatable portions 200 may comprise an actuator 201 such as a button 202 on the aerosol provision system 1, or a portion of a user interface, such as an icon 256, which is configured to be displayed on a touch-sensitive display 254 from the customisable system 300.

There has also been described the following embodiments as set out in the following numbered clauses:

1. An electrical device for use with an aerosol provision system for generating an aerosol, wherein the electrical device comprises:
a display; and
at least one actuatable portion, wherein each user actuatable portion is operable to effect a respective function, wherein each user actuatable portion is configured to be displayed on the display, and is configured to be customisable for allowing the function of the aerosol provision system for that user actuatable portion to be selected from a plurality of different predetermined functions.

2. An electrical device according to clause 1, wherein each user actuatable portion is further operable to effect a respective function of a second aerosol provision system, and is configured to be customisable for allowing the function of the second aerosol provision system for that user actuatable portion to be selected from a plurality of different predetermined functions.

3. An electrical device according to any preceding clause, wherein the electrical device is configured, for each aerosol provision system, to output an indication of the respective aerosol provision system on the display.

4. An electrical device according to clause 3, wherein the indication comprises a graphical representation of the aerosol provision system.

5. An electrical device according to any preceding clause, wherein each user actuatable portion is configured to be displayed on a respective portion of a user interface which is configured to be displayed on the display.

6. An electrical device according to clause 5, wherein the portion of the user interface comprises an icon.

7. An electrical device according to clause 5 or 6, when further dependent on clause 2, wherein the electrical device is configured is allow a user of the electrical device to toggle the user interface between:
a first portion of the user interface which is configured to allow each actuatable portion to be operable to effect a respective function of the aerosol provision system; and
a second portion of the user interface which is configured to allow each actuatable portion to be operable to effect a respective function of the second aerosol provision system.

8. An electrical device according to clause 7, when further dependent on clause 3,
wherein the indication of the aerosol provision system is configured to be displayed on the first portion of the user interface; and
wherein the indication of the second aerosol provision system is configured to be displayed on the second portion of the user interface.

9. An electrical device according to any preceding clause, wherein the display comprises a touch-sensitive display.

10. An electrical device according to any preceding clause, wherein the electrical device comprises a portable electrical device.

11. An electrical device according to any preceding clause, wherein one of the predetermined functions comprises a function for outputting a feedback signal.

12. An electrical device according to clause 11, wherein the electrical device is configured to output the feedback signal to the aerosol provision system.

13. An electrical device according to any preceding clause, wherein one of the one of the predetermined functions comprises an operation of the aerosol provision system.

14. An electrical device according to clause 13, wherein one of the predetermined functions comprises an operation to switch a mode of operation of the aerosol provision system, from a first mode of operation, to a second mode of operation which is different from the first mode operation.

15. An electrical device according to any of clauses 13-14, wherein one of the predetermined functions comprises an operation which is configured to generate a signal containing usage information for the aerosol provision system.

16. An electrical device according to any of clauses 13-15, wherein one of the predetermined functions comprises an operation which is configured to modify the appearance of the aerosol provision system.

17. An electrical device according to any of clauses 13-16, wherein one of the predetermined functions comprises an operation to lock or unlock the aerosol provision system.

18. An electrical device according to any of clauses 13-17, wherein one of the predetermined functions comprises an operation to control the ability of, and/or prevent, the aerosol provision system from generating an aerosol.

19. An electrical device according to any of clauses 13-18, wherein one of the predetermined functions comprises an operation to modify the power supplied to a vaporiser of the aerosol provision system.

20. An electrical device according to any of clauses 13-19, wherein one of predetermined functions comprises an operation which is to configured output an audio signal.

21. An electrical device according to any preceding clause, wherein the electrical device is configured to display a graphical user interface on the display; and wherein each user actuatable portion is configured to be displayed as part of the graphical user interface on the display.

22. An electrical device according to clause 21, wherein each user actuatable portion is configured to be displayed on a first, optionally a home, portion of the graphical user interface on the display.

23. An electrical device according to clause 22, wherein the first portion of the graphical user interface is configured to display a name of the aerosol provision system.

24. An electrical device according to clause 22 or 23, wherein the first portion of the graphical user interface is configured to display a graphical representation of the aerosol provision system, wherein the graphical representation comprises at least one of a:
i) shape of the aerosol provision system;
ii) model of the aerosol provision system; and/or
iii) colour of the aerosol provision system.

25. An electrical device according to clause 24, when further dependent on clause 23, wherein the first portion of the graphical user interface is configured to display the graphical representation of the aerosol provision system beneath the name of the aerosol provision system.

26. An electrical device according to clause 24 or 25, wherein the first portion of the graphical user interface is configured to display the graphical representation of the aerosol provision system next to each user actuatable portion.

27. An electrical device according to any of clauses 22-26, wherein the first portion of the graphical user interface is configured to display each user actuatable portion at the same time.

28. An electrical device according to any of clauses 22-27, wherein each user actuatable portion is configured to be displayed on a same half/side of the first portion of the graphical user interface.

29. A customisable system comprising the electrical device according to any preceding clause, and an aerosol provision system for generating an aerosol, wherein the aerosol provision system is configured to communicate with the electrical device.

30. A customisable system according to clause 29, wherein the aerosol provision system is configured to wirelessly communicate with the electrical device.

31. A customisable system according to clause 30, wherein the aerosol provision system is configured to wirelessly communicate with the electrical device via a Bluetooth protocol.

32. A method of using an electrical device configured for use with an aerosol provision system for generating an aerosol, wherein the method comprises:
customising the operation of at least one user actuatable portion, which is displayed on a display of the electrical device, and which is configured to effect a function when the user actuatable portion is operated, by selecting the function from a plurality of different predetermined functions.

Appreciating the above disclosure as well, it will be appreciated that the present disclosure may thus also conveniently provide for a mechanism to provide multiple user actuatable portions on one same first (potentially home) portion of the graphical user interface 255—from which a user can then operate each user actuatable portion on this same portion of the graphical user interface 255 without needing to navigate to a different portion of the graphical user interface 255. In this way, this first (home) portion of the graphical user interface 255 (e.g. as shown in any of the embodiment of FIGS. 8A-8C) may thus allow a user to conveniently control operations of, or relating to, their aerosol provision system in a more convenient, and easier to use, fashion. This being the case, the present disclosure may thus also provide for the following embodiments as set out in the first set of clauses as listed at the end of this specification.

In order to address various issues and advance the art, this disclosure shows by way of illustration various embodiments in which the claimed invention(s) may be practiced. The advantages and features of the disclosure are of a representative sample of embodiments only, and are not exhaustive and/or exclusive. They are presented only to assist in understanding and to teach the claimed invention(s). It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope of the claims. Various embodiments may suitably comprise, consist of, or consist essentially of, various combinations of the disclosed elements, components, features, parts, steps, means, etc. other than those specifically described herein, and it will thus be appreciated that features of the dependent claims may be combined with features of the independent claims in combinations other than those explicitly set out in the claims. The disclosure may include other inventions not presently claimed, but which may be claimed in future.

For instance, in terms of how any user actuatable portion 200 may be appropriately powered (where necessary), it will be appreciated that each user actuatable portion 200 may be powered using any required power supply, such as using power supply 16 (as shown in the embodiment of FIG. 7 or 8) in some embodiments where the user actuatable portion 200 comprises an actuator 201 on the aerosol provision system 1, or each powered with its own power source (not shown in the Figures).

Equally, with regard to the positioning of any such user actuatable portion(s) 200, it will be appreciated that their location(s) may be provided anywhere in the customisable system 300 as may be required to allow them to provide their required functionality. In this respect for instance, the user actuatable portion(s) 200 need not necessarily located on the aerosol provision system 1 (e.g. could instead be located as part of a separate device which is attachable to the user, such as a strap or some other patch or device which may be secured (releasably if needs be, e.g. via an adhesive patch, to the user).

For the sake of completeness as well, in respect of any user actuatable portion(s) 200, it will be appreciated that any power or signals sent thereto or therefrom may be provided using either a wired or wireless connection 270 between the feedback portion 200 and the aerosol provision system 1 for effecting the function of the user actuatable portion 200.

In the above embodiments therefore, it may be seen that any combination or number of user actuatable portion(s) 200 (e.g. one, two, three, four or any other integer number) may be employed, as required, to suit the intended functionality of the customisable system 300.

Finally, it is to also be appreciated that where any user actuatable portion(s) is employed, some or all of these may in fact not necessarily be customisable. In this way however, each user actuatable portion 200 may however still have a benefit through it acting as a convenient mechanism for effecting a predetermined function of, or relating to, the aerosol provision system 1. For instance, and with reference to the embodiments to FIGS. 8A and 8C at least, in some embodiments thereof, the function of each user actuatable portion(s) 200 may be fixed or not necessarily customisable. In this way therefore, and at a general level, there may nonetheless be provided an electrical device for use with an aerosol provision system for generating an aerosol, wherein the electrical device comprises: a display; and a plurality of actuatable portions, wherein each user actuatable portion is operable to effect a respective function, wherein each user actuatable portion is configured to be displayed on the display. In so far as such an embodiment is employed, which appreciably may not be necessarily customisable, this embodiment may still provide the user with a convenient mechanism to effect different functions of one or more aerosol provisions systems 1; 1A (e.g. via any provided toggle portion 290) in a convenient and quick manner. For completeness in this instance, any such embodiment may appreciably comprise any combination of other features described herein, such as any of those features from the above recited description; clauses; or subsequently recited claims.

### First Set of Clauses

1. An electrical device for use with an aerosol provision system for generating an aerosol, wherein the electrical device comprises:
a display; and
a plurality of actuatable portions, wherein each user actuatable portion is operable to effect a respective function of, and/or a respective function relating to, the aerosol provision system, wherein each user actuatable portion is configured to be displayed as part of a graphical user interface on the display;
wherein the plurality of actuatable portions is configured to be displayed on a first, home, portion of the graphical user interface on the display at the same time.

2. An electrical device according to clause 1, wherein the first portion of the graphical user interface is further configured to display a name of the aerosol provision system.

3. An electrical device according to any preceding clause, wherein the first portion of the graphical user interface is further configured to display a graphical representation of the aerosol provision system.

4. An electrical device according to clause 3, wherein the graphical representation comprises a shape of the aerosol provision system.

5. An electrical device according to clause 3 or 4, wherein the graphical representation comprises a model of the aerosol provision system.

6. An electrical device according to clause 3, wherein the graphical representation comprises a colour of the aerosol provision system.

7. An electrical device according to clause 3, when further dependent on clause 2, wherein the first portion of the graphical user interface is configured to display the graphical representation of the aerosol provision system beneath the name of the aerosol provision system.

8. An electrical device according to any of clauses 3-7, wherein the first portion of the graphical user interface is configured to display the graphical representation of the aerosol provision system next to each user actuatable portion.

9. An electrical device according to any preceding clause, wherein the plurality of actuatable portions are configured to be displayed on a same half/side of the first portion of the graphical user interface.

10. An electrical device according to any preceding clause, wherein the first portion of the user interface further comprises at least one toggle portion for allowing a user to change the user interface from the first portion to a second portion, wherein the second portion is configured to relate to a second aerosol provision system which is different from the aerosol provision system.

11. An electrical device according to any preceding clause, wherein one of the predetermined functions comprises an operation to lock or unlock the aerosol provision system.

12. An electrical device according to any preceding clause, wherein one of the predetermined functions comprises an operation to control the ability of, and/or prevent, the aerosol provision system from generating an aerosol.

13. An electrical device according to any preceding clause, wherein one of the predetermined functions comprises an operation to modify the power supplied to a vaporiser of the aerosol provision system.

14. A system comprising the electrical device according to any preceding clause, and an aerosol provision system for generating an aerosol, wherein the aerosol provision system is configured to communicate with the electrical device.

15. A system according to clause 14, when further dependent on clause 10 at least, further comprising the second aerosol provision system for generating an aerosol, wherein the second aerosol provision system is configured to communicate with the electrical device.

16. A system according to clause 14 or 15, wherein each aerosol provision system is configured to wirelessly communicate with the electrical device.

17. A system according to clause 16, wherein each aerosol provision system is configured to wirelessly communicate with the electrical device via a Bluetooth protocol.

17. A method of using an electrical device configured for use with an aerosol provision system for generating an aerosol, wherein the method comprises:
displaying, at the same time, a plurality of actuatable portions as part of a graphical user interface on a display from the electrical device;
wherein each user actuatable portion is operable to effect a respective function of, and/or a respective function relating to, the aerosol provision system; and
wherein the plurality of actuatable portions are displayed on a first, home, portion of the graphical user interface on the display at the same time.

18. A method according to clause 17, wherein the method further comprises;
operating at least one toggle portion from the graphical user interface for allowing a user to change the user interface from the first portion to a second portion of the graphical user interface, wherein the second portion is configured to relate to a second aerosol provision system which is different from the aerosol provision system.

19. A method according to clause 18, wherein the method further comprises:
displaying a second plurality of actuatable portions, at a same time, on the second portion of the graphical user interface,
wherein each user actuatable portion from the second plurality of actuatable portions is operable to effect a respective function of, and/or a respective function relating to, the second aerosol provision system.

20. A method according to any of clauses 17-19, wherein the method further comprises:
displaying a name of the aerosol provision system on the first portion of the graphical user interface at the same time as displaying the plurality of actuatable portions on the first portion.

21. A method according to any of clauses 17-20, wherein the method further comprises:
displaying a graphical representation of the aerosol provision system on the first portion of the graphical user interface on the display at the same time as displaying the plurality of actuatable portions on the first portion.

22. A method according to any of clauses 17-21, wherein the method further comprises:
displaying the plurality of actuatable portions on a same half/side of the first portion of the graphical user interface.

23. A method according to clause 22, when further dependent on clause 19 at least, wherein the method further comprises:
displaying the second plurality of actuatable portions on a same half/side of the second portion of the graphical user interface;
wherein the half/side of the second portion of the graphical user interface is the same as the half/side of the first portion of the graphical user interface.

24. A method according to any of clauses 17-23, wherein the electrical device comprises a smartphone.

1. A customisable system comprising:
an aerosol provision system for generating an aerosol; and
one or more user actuatable portions which are each operable to effect a respective function, wherein each user actuatable portion is configured to be customisable for allowing the function of that user actuatable portion to be selected from a plurality of different predetermined functions.

2. A customisable system according to claim 1, wherein one of the predetermined functions comprises a function for outputting a feedback signal.

3. A customisable system according to claim 2, wherein the customisable system is configured to output the feedback signal to the aerosol provision system;
or wherein the customisable system is configured to output the feedback signal to an electrical device.

4-5. (canceled)

6. A customisable system according to claim 2, wherein the feedback comprises any combination of:
i) acoustic feedback;
ii) haptic feedback; and
iii) visual feedback.

7. A customisable system according to claim 1, wherein one of the one of the predetermined functions comprises an operation of the aerosol provision system.

8. A customisable system according to claim 7, wherein one of the predetermined functions comprises an operation to switch a mode of operation of the aerosol provision system, from a first mode of operation, to a second mode of operation which is different from the first mode operation.

9. A customisable system according to claim 7, wherein one of the predetermined functions comprises an operation which is configured to generate a signal containing usage information for the aerosol provision system.

10. A customisable system according to claim 7, wherein one of the predetermined functions comprises an operation which is configured to modify the appearance of the aerosol provision system.

11. A customisable system according to claim 7, wherein one of predetermined functions comprises an operation which is configured to output an audio signal.

12. A customisable system according to claim 1, wherein the customisable system is configured to allow the user to select the function from a list of different predetermined functions.

13. A customisable system according to claim 1, wherein at least one of the user actuatable portions comprises an actuator, the actuator comprising a button.

14. (canceled)

15. A customisable system according to claim 1, wherein the customisable system comprises a touch-sensitive display, wherein each user actuatable portion comprises a respective portion of a user interface which is configured to be displayed on the touch-sensitive display.

16. (canceled)

17. A customisable system according to claim 1, wherein at least one of the user actuatable portions is located on the aerosol provision system.

18. A customisable system according to claim 1, wherein at least one of the user actuatable portions is configured to be located on an electrical device which is operable to wirelessly communicate with the aerosol provision system.

19-20. (canceled)

21. An aerosol provision device for an aerosol provision system comprising a cartridge and the aerosol provision device, wherein the aerosol provision device comprises:
one or more user actuatable portions which are each operable to effect a respective function, wherein each user actuatable portion is configured to be customisable for allowing the function of that user actuatable portion to be selected from a plurality of different predetermined functions.

22. A method of customising the operation of a customisable system comprising an aerosol provision system for generating an aerosol, wherein the method comprises:
customising the operation of a user actuatable portion, from the customisable system, and which is configured to effect a function when the user actuatable portion is operated, by selecting the function from a plurality of different predetermined functions.

23. A method according to claim 22, wherein the method further comprises:
operating the user actuatable portion to effect the function.

24. A method according to claim 22, wherein the method further comprises:
customising the operation of a second user actuatable portion, from the customisable system, and which is configured to effect a second function when the second user actuatable portion is operated, by selecting the second function from the plurality of different predetermined functions.

25. A method according to claim 24, wherein the method further comprises:
operating at least one of i) the user actuatable portion to effect the function; and/or ii) the second user actuatable portion to effect the second function.

26. A method of operating a customisable system comprising an aerosol provision system for generating an aerosol, wherein the method comprises:
operating at least one user actuatable portion from the customisable system to effect a respective function, wherein each user actuatable portion is configured to be customisable for allowing the respective function of that user actuatable portion to be selected from a plurality of different predetermined functions.

27-30. (canceled)
